(19) United States
(12) Patent Application Publication
(10) Pub. No.: US 2015/0114111 A1
(43) Pub. Date: Apr. 30, 2015

(54) MEMS SENSOR AND DEVICE HAVING THE SAME

(71) Applicant: SAMSUNG ELECTRO-MECHANICS CO., LTD., Suwon-si (KR)

(72) Inventors: Won Kyu Jeung, Suwon-si (KR); Chang Hyun Lim, Suwon-si (KR); Jung Won Lee, Suwon-si (KR); Jong Hyeong Song, Suwon-si (KR)

(73) Assignee: SAMSUNG ELECTRO-MECHANICS CO., LTD., Suwon-si (KR)

(21) Appl. No.: 14/181,869

(22) Filed: Feb. 17, 2014

(30) Foreign Application Priority Data
Oct. 29, 2013 (KR) 10-2013-0129085

(51) Int. Cl. G01P 1/02; G01P 1/00

(52) U.S. Cl. CPC G01P 1/02; G01P 1/006
USPC 73/488

(57) ABSTRACT

Disclosed herein is an MEMS sensor, including: a sensor unit; and a substrate connected to the sensor unit, in which the substrate may be provided with a flexible printed circuit board (FPCB) to correspond to an outer peripheral portion of the sensor unit.

### CROSS REFERENCE TO RELATED APPLICATION

This application claims the benefit of Korean Patent Application No. 10-2013-0129085, filed on Oct. 29, 2013, entitled “MEMS Sensor and Device Having the Same”, which is hereby incorporated by reference in its entirety into this application.

### BACKGROUND OF THE INVENTION

1. Technical Field

The present invention relates to an MEMS sensor and a device having the same.

2. Description of the Related Art

Generally, an MEMS sensor has been variously used in a car, aircraft, mobile communication terminals, toys, and the like and requires a multi-axes acceleration sensor and a multi-axes angular velocity sensor and has been developed to have high performance and be miniaturized to detect a minute acceleration.

Further, a device having the MEMS sensor is very sensitive to a change in external stress.

Recently, the sensor has been widely adopted in mobile devices in addition to cellular phones. The reason is that a micro electro mechanical system (MEMS) technology capable of manufacturing devices requiring various applications and various sensors and actuators in a small size is being developed.

Further, the device including the MEMS sensor has a structure to sensitively react to a change in various stresses or external forces applied from the outside in addition to a change in physical quantities.

Therefore, blocking the stresses or the external forces applied from the outside may be considered as very important factors in manufacturing a high-performance sensor.

Further, removing the stresses or the external forces generated after the manufacturing of the sensor may be considered as very important factors.

That is, when the MEMS sensor according to the prior art including Prior Art Document is applied with the stresses due to an external impact, and the like, sensing efficiency may be reduced and a damage of the sensor or an unbalance of the system may occur. Further, to cope with the problem, a separate stress blocking structure to block the stresses is required. In this case, a size may be large and productivity may be reduced.

### PRIOR ART DOCUMENT

### Patent Document

(Patent Document 1) US 20060156818 A

### SUMMARY OF THE INVENTION

The present invention has been made in an effort to provide an MEMS sensor capable of improving reliability and a device having the same, by attenuating and offsetting a thermal deformation or an external stress delivered from the external board to the substrate by forming a flexible printed circuit board (FPCB) on a substrate not to be delivered to a sensor unit and preventing sensitivity of the sensor unit from reducing and the sensor unit from being damaged due to the external stress.

Further, the present invention has been made in an effort to provide an MEMS sensor and a device having the same capable of offsetting and attenuating an external stress by forming a groove part or a hollow part on a substrate and optimizing system stabilization of the MEMS sensor in consideration of a resonance frequency at the time of forming the groove part or the hollow part.

According to a preferred embodiment of the present invention, there is provided an MEMS sensor, including: a sensor unit; and a substrate connected to the sensor unit, in which the substrate may be provided with a flexible printed circuit board (FPCB) to correspond to an outer peripheral portion of the sensor unit.

The flexible printed circuit board may be formed to surround a portion or the whole of the circumference of the sensor unit.

The MEMS sensor may further include: an ASIC connected to the sensor unit and electrically connected to the substrate.

The ASIC may be connected to the substrate by a wire bonding.

According to another preferred embodiment of the present invention, there is provided an MEMS sensor, including: a sensor unit; and a substrate connected to the sensor unit, in which the substrate may be provided with a groove part or a hollow part to correspond to an outer peripheral portion of the sensor unit.

The groove part or the hollow part may be formed to surround a portion or the whole of the circumference of the sensor unit.

The MEMS sensor may further include an ASIC connected to the sensor unit and electrically connected to the substrate, in which the ASIC may be connected to the substrate by a wire bonding.

According to another preferred embodiment of the present invention, there is provided a device, including: an MEMS sensor including a sensing unit and a substrate connected to the sensing unit, the substrate being provided with a flexible printed circuit board (FPCB) to correspond to an outer peripheral portion of the sensor unit; and an external board connected to the substrate.

The external board and the substrate may be connected to each other by a solder and the solder may be formed at an outer peripheral portion of the flexible printed circuit board.

According to still another preferred embodiment of the present invention, there is provided a device, including: an MEMS sensor including a sensing unit and a substrate connected to the sensing unit, the substrate being provided with a groove part or a hollow part to correspond to an outer peripheral portion of the sensor unit; and an external board connected to the substrate.

The external board and the substrate may be connected to each other by a solder and the solder may be formed at an outer peripheral portion of the groove part or the hollow part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view schematically illustrating a configuration of an MEMS sensor according to a first preferred embodiment of the present invention;

FIG. 2 is a schematic plan view illustrating various examples of a sensor unit and a substrate in the MEMS sensor illustrated in FIG. 1;

FIG. 3 is a cross-sectional view schematically illustrating an example in which the MEMS sensor illustrated in FIG. 1 is mounted in a device;

FIG. 4 is a use state diagram schematically illustrating a case in which an external stress is delivered to the MEMS sensor illustrated in FIG. 3;

FIG. 5 is a cross-sectional view schematically illustrating a configuration of an MEMS sensor according to a second preferred embodiment of the present invention;

FIG. 6 is a schematic plan view illustrating various examples of a sensor unit and a substrate in the MEMS sensor illustrated in FIG. 5;

FIG. 7 is a cross-sectional view schematically illustrating an example in which the MEMS sensor illustrated in FIG. 5 is mounted in a device;

FIG. 8 is a use state diagram schematically illustrating a case in which an external stress is delivered to the MEMS sensor illustrated in FIG. 7;

FIG. 9 is a cross-sectional view schematically illustrating a configuration of an MEMS sensor according to a third preferred embodiment of the present invention; and

FIG. 10 is a schematic plan view illustrating a sensor unit and a substrate in the MEMS sensor illustrated in FIG. 9.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

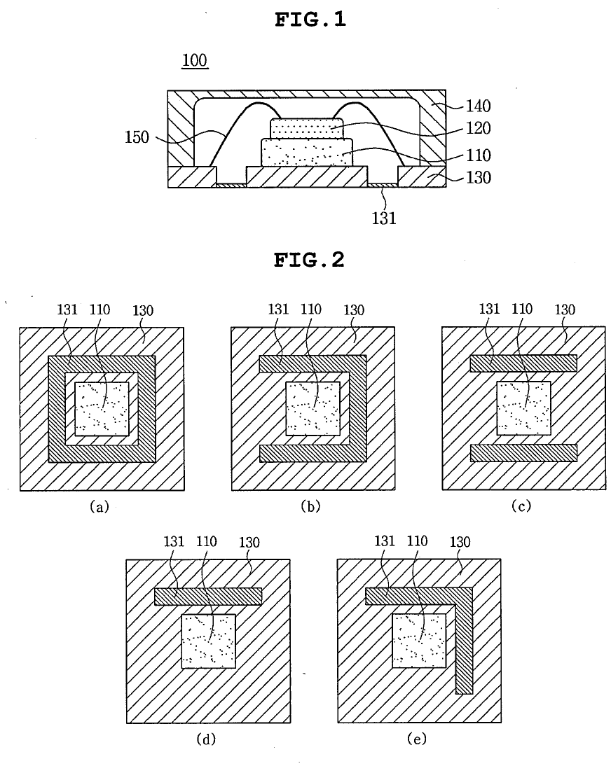

FIG. 1 is a cross-sectional view schematically illustrating a configuration of an MEMS sensor according to a first preferred embodiment of the present invention; As illustrated in FIG. 1, an MEMS sensor 100 includes a sensor unit 110, an application specific integrated circuit (ASIC) 120, a substrate 130, and a cover 140, in which the substrate 130 is provided with a flexible printed circuit board (FPCB) 131 to correspond to an outer peripheral portion of the sensor unit 110.

In more detail, the sensor unit 110 includes a sensing means to measure a change in physical quantities. To this end, the sensor unit 110 includes a weight body and measures a displacement of the weight body to be able to detect the physical quantities. Further, as a method of detecting physical quantities, a capacitive method, a piezoelectric method, and a piezoresistive method may be adopted, in which the capacitive method measures a change in capacitance to the displacement of the weight body, the piezoelectric method measures a change in charge quantity generated from a piezoelectric material, and the piezoresistive method measures a change in resistance of a piezoreistor.

Further, the ASIC 120 controls the sensor unit 110 and calculates physical quantities including acceleration and angular velocity and is electrically connected to the sensor unit 110.

Further, the ASIC 120 is electrically connected to the substrate 130 by a wire 150 bonding. Further, the sensor unit 110 may input/output information to/from an external board through the substrate 130.

Further, the cover 140 is connected to the substrate 130 to cover the sensor unit 110 and the ASIC 120.

The ASIC 120 is stacked on the sensor unit 110 and as described above, the ASIC 120 is electrically connected to the substrate 130 by the wire 150 bonding. Further, unlike one illustrated in FIG. 1, the sensor unit 110 is stacked on the ASIC 120 and the sensor unit 110 may be electrically connected to the substrate 130 by the wire bonding.

Further, when the sensor unit 110 is stacked on the substrate 130, the flexible printed circuit board (FPCB) 131 on the substrate 130 may be formed to surround a portion or the whole of the circumference of the sensor unit 110. This is to prevent an external stress delivered from the external board from being delivered to the sensor unit 110.

Further, the flexible printed circuit board (FPCB) 131 may be formed of a flexible substrate on which a circuit is not printed.

To this end, various examples of the flexible printed circuit board (FPCB) 131 are illustrated in FIG. 2. In more detail, FIG. 2A illustrates that the whole circumference of the sensor unit 110 is surrounded with the flexible printed circuit board (FPCB) 131. Further, FIGS. 2B to 2E illustrate that a portion of the circumference of the sensor unit 110 is surrounded with the flexible printed circuit board (FPCB) 131.

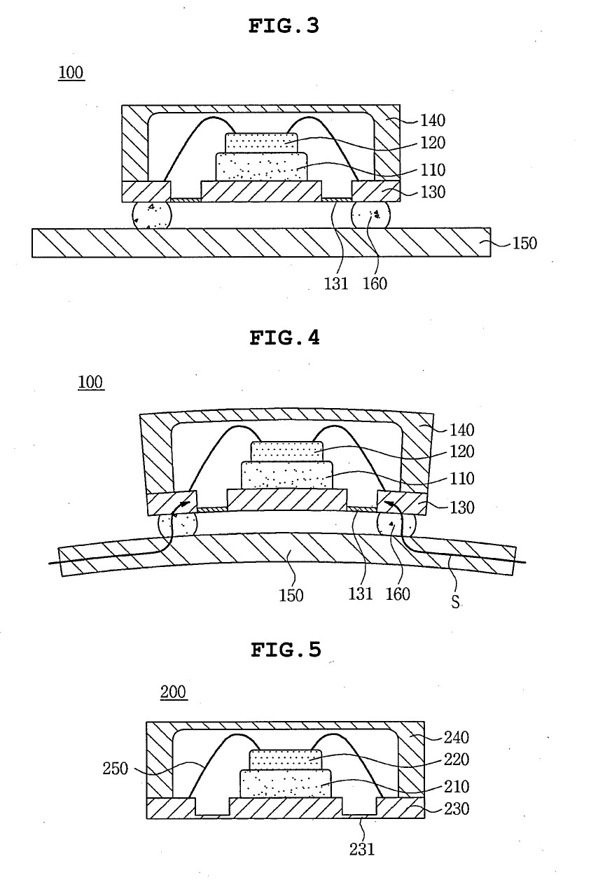

According to the configuration described above, as the external stress is offset and attenuated by the flexible printed circuit board (FPCB) 131, the stress delivery to the sensor unit 110 may be blocked. The technology to achieve this purpose will be described in more detail with reference to FIGS. 3 and 4.

FIG. 3 is a cross-sectional view schematically illustrating an example in which the MEMS sensor illustrated in FIG. 1 is mounted in a device and FIG. 4 is a use state diagram schematically illustrating a case in which an external stress is delivered to the MEMS sensor illustrated in FIG. 3.

As illustrated in FIGS. 3 and 4, the MEMS sensor 100 includes the sensor unit 110, the ASIC 120, the substrate 130, and the cover 140 and the substrate 130 is provided with the flexible printed circuit board (FPCB) 131 and the substrate 130 is electrically and physically connected to the external board 150 by a solder 160.

Further, the solder 160 is formed at an outside of the flexible printed circuit board (FPCB) 131 which is formed at an outside of the sensor unit 110.

By the above configuration, as illustrated in FIG. 4, when a thermal deformation or an external stress S is delivered from the external board 150 to the substrate 130 through the solder 160, the external stress S is attenuated by the flexible printed circuit board (FPCB) 131 and thus is not delivered to the sensor unit 110. Therefore, the reduction in sensitivity and the damage of the sensor unit 110 due to the external stress S may be prevented, such that a reliable MEMS sensor may be obtained.

In addition, the MEMS sensor 100 does not require a separate stress blocking structure, such as a buffer layer, the MEMS sensor 100 may be small and lightweight and productivity thereof may be increased.

FIG. 5 is a cross-sectional view schematically illustrating a configuration of an MEMS sensor according to a second preferred embodiment of the present invention. As illustrated in FIG. 5, an MEMS sensor 200 includes a sensor unit 210, an ASIC 220, a substrate 230, and a cover 240, in which the substrate 230 is provided with a groove part 231 to correspond to an outer peripheral portion of the sensor unit 210.

Further, the sensor unit 210, the ASIC 220, and the cover 240 are the same as the technical components of the MEMS sensor according to the first preferred embodiment of the present invention, and therefore the detailed technical matters thereof are omitted.

Further, the ASIC 220 is stacked on the sensor unit 210 and the ASIC 220 is electrically connected to the substrate 230 by a wire 250 bonding.

Meanwhile, when the sensor unit 210 is stacked on the substrate 230, a groove part 231 of the substrate 230 may be formed to surround a portion or the whole of the circumference of the sensor unit 210. This is to allow the groove part 231 to offset the external stress delivered from the external board and prevent the external stress from being delivered to the sensor unit 210.

Further, the groove part 231 may be formed to optimize system stabilization of the MEMS sensor 200 in consideration of a resonance frequency of the MEMS sensor 200.

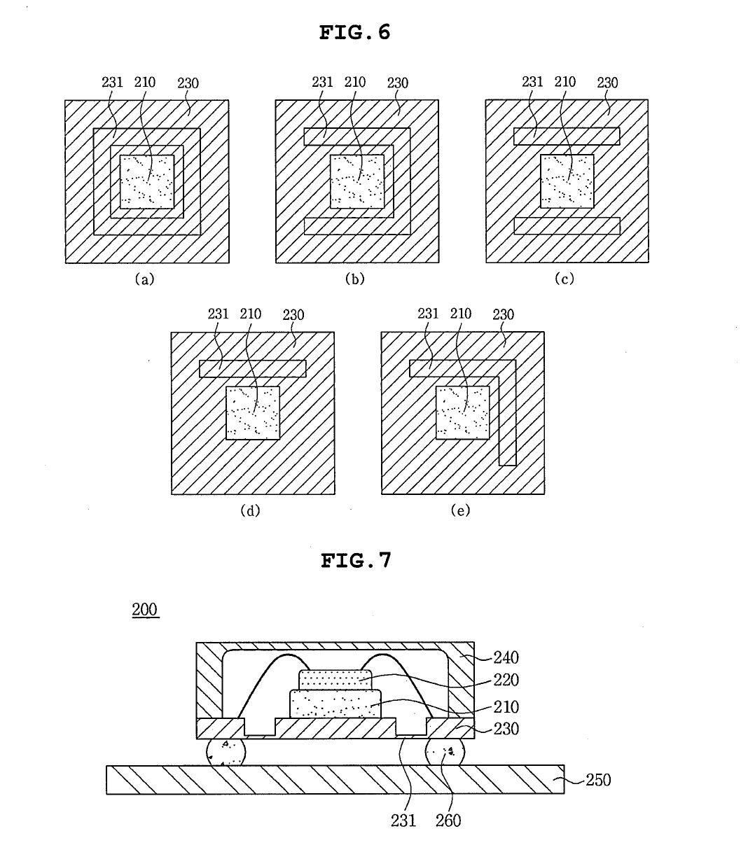

To this end, various examples of the groove part 231 are illustrated in FIG. 6. In more detail, FIG. 6A illustrates that the whole circumference of the sensor unit 210 is surrounded with the groove part 231. Further, FIGS. 6B to 6E illustrate that a portion of the circumference of the sensor unit 210 is surrounded with the groove part 231.

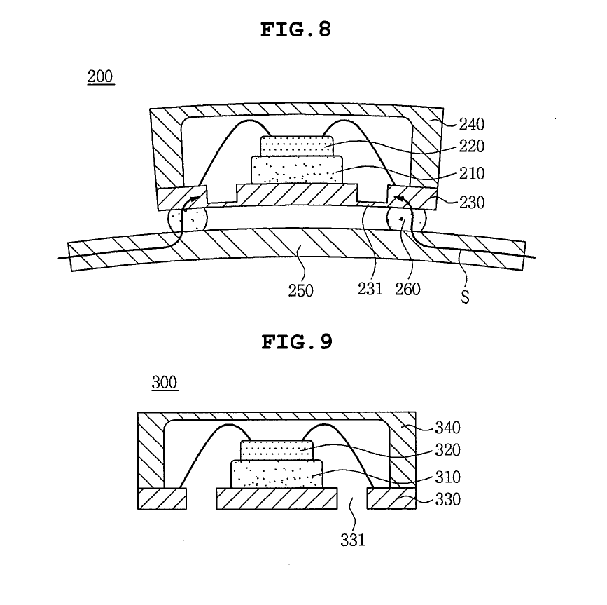

According to the configuration described above, as the external stress is offset and attenuated by the groove part 231, the stress delivery to the sensor unit 210 may be blocked. The technology to achieve this purpose will be described in more detail with reference to FIGS. 7 and 8.

FIG. 7 is a cross-sectional view schematically illustrating an example in which the MEMS sensor illustrated in FIG. 1 is mounted in a device and FIG. 8 is a use state diagram schematically illustrating a case in which an external stress is delivered to the MEMS sensor illustrated in FIG. 7.

As illustrated in FIGS. 7 and 8, the MEMS sensor 200 includes the sensor unit 210, the ASIC 220, the substrate 230, and the cover 240 and the substrate 230 is provided with the groove part 231 and the substrate 230 is electrically and physically connected to the external board 250 by a solder 260.

Further, the solder 260 is formed at an outside of the groove part 231 which is formed at an outside of the sensor unit 210.

By the above configuration, as illustrated in FIG. 8, when the thermal deformation or the external stress S is delivered from the external board 250 to the substrate 230 through the solder 260, the external stress S is attenuated by the groove part 231 and thus is not delivered to the sensor unit 210. Therefore, the reduction in sensitivity and the damage of the sensor unit 210 due to the external stress S may be prevented, such that the reliable MEMS sensor may be obtained.

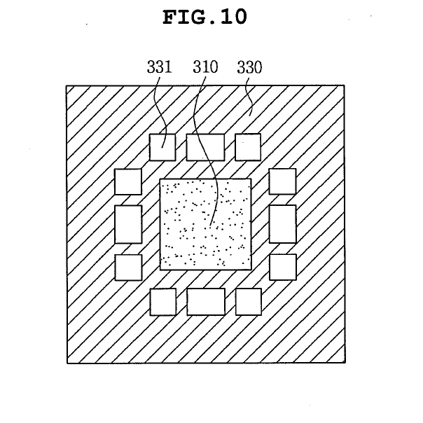

FIG. 9 is a cross-sectional view schematically illustrating a configuration of an MEMS sensor according to a third preferred embodiment of the present invention and FIG. 10 is a schematic plan view illustrating a sensor unit and a substrate in the MEMS sensor illustrated in FIG. 9. As illustrated in FIGS. 9 and 10, an MEMS sensor 300 according to a third preferred embodiment of the present invention includes a sensor unit 310, an ASIC 320, a substrate 330, and a cover 340, in which the substrate 230 is provided with a hollow part 331.

Further, the MEMS sensor 300 is different from the MEMS sensor 200 according to the second preferred embodiment of the present invention illustrated in FIG. 5 in terms of only the substrate shape, and therefore the description of other components will be omitted.

In more detail, the substrate 330 of the MEMS sensor 300 is provided with the hollow part 331. Further, as illustrated in FIG. 10, the hollow part 331 may be formed in plural to surround the circumference of the sensor unit 310.

Further, like the groove part 231 of the MEMS sensor 200 according to the second preferred embodiment of the present invention, the hollow part 331 may be formed to optimize the system stabilization of the MEMS sensor 300 in consideration of the resonance frequency of the MEMS sensor 300.

By the above configuration, according to the MEMS sensor 300 according to the third preferred embodiment of the present invention, when the external stress S is delivered from the external board to the substrate 330, the external stress is attenuated and blocked by the hollow part 330 and thus is not delivered to the sensor unit 310. Therefore, the reduction in sensitivity and the damage of the sensor unit 310 due to the external stress S may be prevented, such that the reliable MEMS sensor may be obtained.

According to the preferred embodiments of the present invention, it is possible to provide the MEMS sensor capable of improving reliability and the device having the same, by attenuating and offsetting the thermal deformation or the external stress delivered from the external board to the substrate by forming the flexible printed circuit board (FPCB) on the substrate not to be delivered to the sensor unit and preventing the sensitivity of the sensor unit from reducing and the sensor unit from being damaged due to the external stress and it is possible to provide the MEMS sensor and the device having the same capable of offsetting and attenuating the external stress by forming the groove part or the hollow part on the substrate and optimizing the system stabilization of the MEMS sensor in consideration of the resonance frequency at the time of forming the groove part or the hollow part.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An MEMS sensor, comprising:
a sensor unit; and
a substrate connected to the sensor unit,
wherein the substrate is provided with a flexible printed circuit board (FPCB) to correspond to an outer peripheral portion of the sensor unit.

2. The MEMS sensor as set forth in claim 1, wherein the flexible printed circuit board is formed to surround a portion or the whole of the circumference of the sensor unit

3. The MEMS sensor as set forth in claim 1, further comprising:
an ASIC connected to the sensor unit and electrically connected to the substrate.

4. The MEMS sensor as set forth in claim 3, wherein the ASIC is connected to the substrate by a wire bonding.

5. An MEMS sensor, comprising:
a sensor unit; and
a substrate connected to the sensor unit,
wherein the substrate is provided with a groove part or a hollow part to correspond to an outer peripheral portion of the sensor unit.

6. The MEMS sensor as set forth in claim 5, wherein the groove part or the hollow part is formed to surround a portion or the whole of the circumference of the sensor unit

7. The MEMS sensor as set forth in claim 5, further comprising:
an ASIC connected to the sensor unit and electrically connected to the substrate, wherein the ASIC is connected to the substrate by a wire bonding.

8. A device, comprising:
an MEMS sensor including a sensing unit and a substrate connected to the sensing unit, the substrate being provided with a flexible printed circuit board (FPCB) to correspond to an outer peripheral portion of the sensor unit; and
an external board connected to the substrate.

9. The device as set forth in claim 8, wherein the external board and the substrate are connected to each other by a solder and the solder is formed at an outer peripheral portion of the flexible printed circuit board.

10. A device, comprising:
an MEMS sensor including a sensing unit and a substrate connected to the sensing unit, the substrate being provided with a groove part or a hollow part to correspond to an outer peripheral portion of the sensor unit; and
an external board connected to the substrate.

11. The device as set forth in claim 10, wherein the external board and the substrate are connected to each other by a solder and the solder is formed at an outer peripheral portion of the groove part or the hollow part.
